(19) United States
(12) Patent Application Publication
(10) Pub. No.: US 2006/0291349 A1
(43) Pub. Date: Dec. 28, 2006

(54) Signal processing apparatus for reproducing optical disc, optical disc reproducing apparatus and RF signal equalizer gain adjustment method

(75) Inventor: Ryouichi Ishikawa, Kyoto (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/455,941

(22) Filed: Jun. 20, 2006

(30) Foreign Application Priority Data
Jun. 22, 2005 (JP) 2005-181381

(51) Int. Cl. G11B 15/52; G11B 20/18

(52) U.S. Cl. 369/47.25; 369/53.35

(57) ABSTRACT

For every optical disc to be played back, an OFT signal detecting apparatus detects an OFT signal, from which an asymmetric optical disc is identified. Upon identification of such a disc, when written data are asymmetric, an equalizer characteristic changing apparatus changes the equalizer gain setting regarding an RF signal, thereby making it possible for an LSI for reproducing of optical disc to normally identify and play back even such an optical disc which has heretofore been impossible to play back.

### BACKGROUND OF THE INVENTION

1. Field of the Invention

The present invention relates to a signal processing apparatus for reproducing an optical disc, an optical disc reproducing apparatus (including a CD player) and an RF (Radio Frequency) signal equalizer gain adjustment method for reproducing various types of optical discs including CDs (Compact Discs) and DVDs (Digital Versatile Discs). The present invention particularly relates to a method which makes it possible to read data even when the quality of an RF signal read from an optical disc is poor.

2. Description of Related Art

An RF signal read from an optical disc contains various types of frequency components, and from a combination of these, data written on the optical disc are identified. A general trend is that the amplitude of an RF signal becomes narrower as the frequency of an RF signal rises, owing to a frequency characteristic of a pick-up. When the amplitude of an RF signal is narrow, it is difficult to identify data which are represented by the RF signal. A conventional approach to improve this is to pass the RF signal through an equalizer and accordingly enhance the amplitude of a high frequency component. A high amplitude enhancement rate however could result in distortion of the RF signal and the difficulty in reading data. Noting this, using various discs, an average equalizer having a determined characteristic has been set.

The recent increasingly popular use of a CD-R (CD recordable) and a CD-RW (CD-ReWritable) gives rise to frequent instances that data can not be written with proper laser power while data are being written. In the case of a disc holding data which were not written with proper laser power, of the written RF signal representing the data, high frequency components are asymmetric. Hence, when a conventional average equalizer is used, during reading of the data, it is not possible to normally identify the data expressed by the high frequency components and it is therefore not possible to read the data.

Included in conventional equalizer switching techniques is switching of an equalizer depending upon a disc to be played back. Patent Literature 1 for instance discloses an example of a circuit for equalizer switching. The Literature is however silent as for how switching is realized under which condition.

As shown in FIG. 9, a conventional optical disc reproducing apparatus comprises a spindle motor 92 which rotates an optical disc 91, a pick-up 93 which reads a signal from the optical disc 91, an RF amplifier 94 which amplifies a signal from the pick-up 93, a servo control chip 95 which computes for servo control in accordance with a signal received from the RF amplifier 94, a driver 96 which amplifies a signal from the servo control chip 95 and drives the pick-up 93 up to a target point for the optical disc 91, and a control microcomputer 97 which controls these.

It is the servo control chip 95 shown in FIG. 9 that identifies data read from the optical disc 91.

An RF signal written with correct laser power in the optical disc reproducing apparatus will now be described with reference to FIG. 10.

FIG. 10 is a waveform diagram of an RF signal written with correct laser power. In FIG. 10, denoted at 101 is a 3T component of the RF signal, denoted at 102 is a 6T component of the RF signal, and denoted at 103 is a 9T component of the RF signal. Data read from an optical disc in which writing was done with correct laser power remain symmetric despite the different amplitudes of different frequency components, which permits identify each signal normally.

FIG. 11 is a waveform diagram of an RF signal read from an optical disc in which writing was done with non-optimal laser power. In FIG. 11, denoted at 111 is a 3T component of the asymmetric RF signal, denoted at 112 is a 6T component of the asymmetric RF signal, and denoted at 113 is a 9T component of the asymmetric RF signal. Data read from the optical disc in which writing was done with non-optimal laser power have a tendency that the higher the frequency component of the RF signal, the higher or the lower voltage side the waveform level shifts to.

The servo control chip 95 detects a cross point of an instantaneous value of each waveform and the center level of the waveform and measures the frequency of each RF signal. A deviation of the level of the waveform from the center level of the waveform therefore makes it impossible to correctly measure the frequency.
Patent Literature 1: Japanese Patent Application Laid-Open Gazette No. 2001-134942.

However, with the conventional method described above, it is not possible to normally identify data and read the data from an optical disc in which high frequency components of an RF signal are asymmetric.

### SUMMARY OF THE INVENTION

The present invention aims at solving the problems with the conventional techniques described above, and accordingly, an object of the present invention is to identify an optical disc in which high frequency components of an RF signal are asymmetric, set an optimal RF equalizer gain and play back even such an optical disc which has heretofore been impossible to be played back.

A first signal processing apparatus for reproducing an optical disc according to the present invention comprises a signal detecting means which detects whether the level of the asymmetric portion of an RF signal is higher than a predetermined level upon occurrence of the asymmetric portion in the high-frequency range of the RF signal read from an optical disc, and an equalizer gain changing means which changes the equalizer gain for the RF signal upon detection by the signal detecting means that the level of the asymmetric portion of the RF signal is higher than the predetermined level.

Using this structure, an optical disc having an asymmetric profile is identified. When it is found that written data are asymmetric, the equalizer gain setting for the RF signal is changed. This makes it possible to judge normally while an LSI (servo control chip) judges data, and hence, to reproducing an optical disc which has heretofore been impossible to be played back.

It is desirable that in this signal processing apparatus for reproducing the optical disc, the signal detecting means detects a black drop out signal (hereinafter abbreviated as an “BDO signal”), and only when it is determined from the BDO signal that the optical disc is free from any scratch, the equalizer gain changing means changes the equalizer gain for the RF signal upon detection by the signal detecting means that the level of the asymmetric portion of the RF signal is higher than the predetermined level.

Further, it is desirable that in this signal processing apparatus for reproducing the optical disc, the signal detecting means detects a tracking lock signal, and only when it is determined from the tracking lock signal that tracking of the optical disc is locked, the equalizer gain changing means changes the equalizer gain for the RF signal upon detection by the signal detecting means that the level of the asymmetric portion of the RF signal is higher than the predetermined level.

Further, it is desirable that in this signal processing apparatus for reproducing the optical disc, the signal detecting means detects a PLL lock signal, and only when it is determined from the PLL lock signal that PLL for the optical disc is locked, the equalizer gain changing means changes the equalizer gain for the RF signal upon detection by the signal detecting means that the level of the asymmetric portion of the RF signal is higher than the predetermined level.

An optical disc reproducing apparatus according to the present invention has a structure which comprises the first signal processing apparatus for reproducing the optical disc described above.

A second signal processing apparatus for reproducing an optical disc according to the present invention comprises an off-track signal detecting means which detects whether the level of the asymmetric portion of an RF signal is higher than the predetermined level upon occurrence of the asymmetric portion in the high-frequency range of the RF signal read from an optical disc and accordingly detects an off-track signal having a higher frequency than a predetermined frequency, and an equalizer gain changing means which changes the equalizer gain for the RF signal read from the optical disc in response to detection by the off-track signal detecting means of the off-track signal whose frequency is higher than the predetermined frequency.

Using this structure, an optical disc having an asymmetric profile is identified. When it is found that written data are asymmetric, the equalizer gain setting for the RF signal is changed. This makes it possible to judge normally while an LSI (servo control chip) judges data, and hence, to reproducing an optical disc which has heretofore been impossible to be played back.

An RF signal equalizer gain adjustment method according to the present invention comprises a signal detecting step of detecting whether the level of the asymmetric portion of an RF signal is higher than a predetermined level upon occurrence of the asymmetric portion in the high-frequency range of the RF signal read from an optical disc, and an equalizer gain changing step of changing the equalizer gain for the RF signal upon detection at the signal detecting step that the level of the asymmetric portion of the RF signal is higher than the predetermined level.

This method requires identifying an optical disc having an asymmetric profile. When it is found that written data are asymmetric, the equalizer gain setting for the RF signal is changed. This makes it possible to judge normally while an LSI (servo control chip) judges data, and hence, to reproducing an optical disc which has heretofore been impossible to be played back.

It is desirable in the RF signal equalizer gain adjustment method described above that a black drop out signal is detected at the signal detecting step, and at the equalizer gain changing step, only when it is determined from the black drop out signal that the optical disc is free from any scratch, the equalizer gain for the RF signal is changed upon detection at the signal detecting step that the level of the asymmetric portion of the RF signal is higher than the predetermined level.

Further, it is desirable in the RF signal equalizer gain adjustment method described above that a tracking lock signal is detected at the signal detecting step, and at the equalizer gain changing step, only when it is determined from the tracking lock that tracking of the optical disc is locked, the equalizer gain for the RF signal is changed upon detection at the signal detecting step that the level of the asymmetric portion of the RF signal is higher than the predetermined level.

Further, it is desirable in the RF signal equalizer gain adjustment method described above that a PLL lock signal is detected at the signal detecting step, and at the equalizer gain changing step, only when it is determined from the PLL lock signal that PLL for the optical disc is locked, the equalizer gain for the RF signal is changed upon detection at the signal detecting step that the level of the asymmetric portion of the RF signal is higher than the predetermined level.

As described above, it is possible according to the present invention to play back even such an optical disc which has heretofore been impossible to play back, as an optical disc in which writing was done with non-optimal laser power is identified without fail and an amplitude enhancement rate is accordingly changed.

### BRIEF DESCRIPTION OF THE DRAWINGS

FIG. 1 is a block diagram which shows the structure of an optical disc reproducing apparatus according to a first embodiment of the present invention;

FIG. 2 is a waveform diagram of an RF signal and an OFT signal in the first embodiment of the present invention;

FIG. 3 is a waveform diagram of the RF signal which is asymmetric and an OFT signal in the first embodiment of the present invention;

FIG. 4 is a waveform diagram of the RF signal having an increased amplitude and the OFT signal in the first embodiment of the present invention;

FIG. 5 is a flow chart of operations which the optical disc reproducing apparatus according to the first embodiment of the present invention performs;

FIG. 6 is a flow chart of operations which an optical disc reproducing apparatus according to a second embodiment of the present invention performs;

FIG. 7 is a flow chart of operations which an optical disc reproducing apparatus according to a third embodiment of the present invention performs;

FIG. 8 is a flow chart of operations which an optical disc reproducing apparatus according to a fourth embodiment of the present invention performs;

FIG. 9 is a block diagram which shows the structure of a conventional optical disc reproducing apparatus;

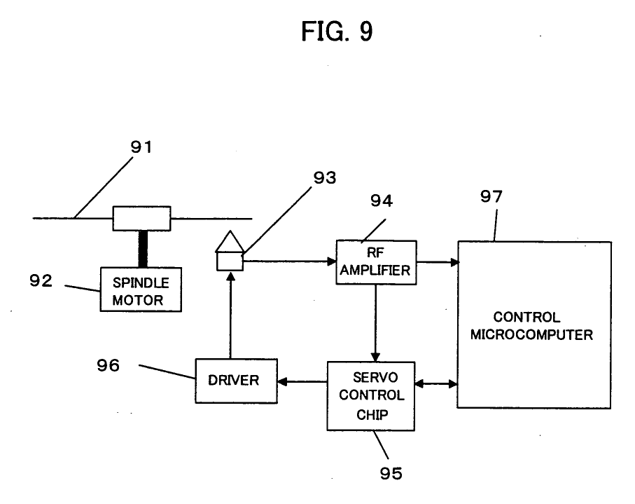

FIG. 10 is a waveform diagram of the RF signal which was written with optimal laser power;

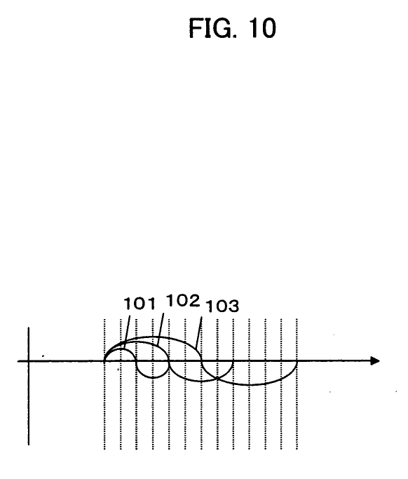

FIG. 11 is a waveform diagram of the RF signal which was written with non-optimal laser power; and

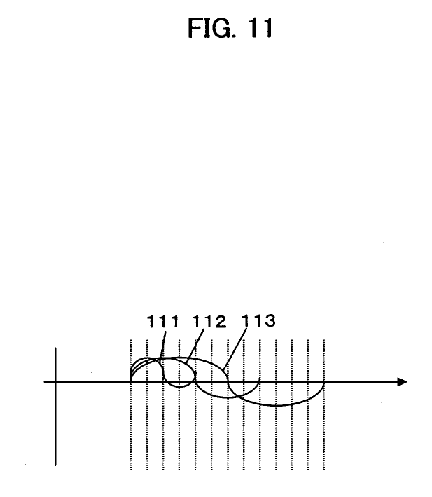

FIG. 12 is a block diagram which shows a specific structure of an RF amplifier.

### DETAILED DESCRIPTION OF THE INVENTION

(First Embodiment)

The signal processing apparatus for reproducing the optical disc according to the first embodiment of the present invention will now be described with reference to the associated drawings. This signal processing apparatus for reproducing the optical disc is formed as a semiconductor device such as an LSI.

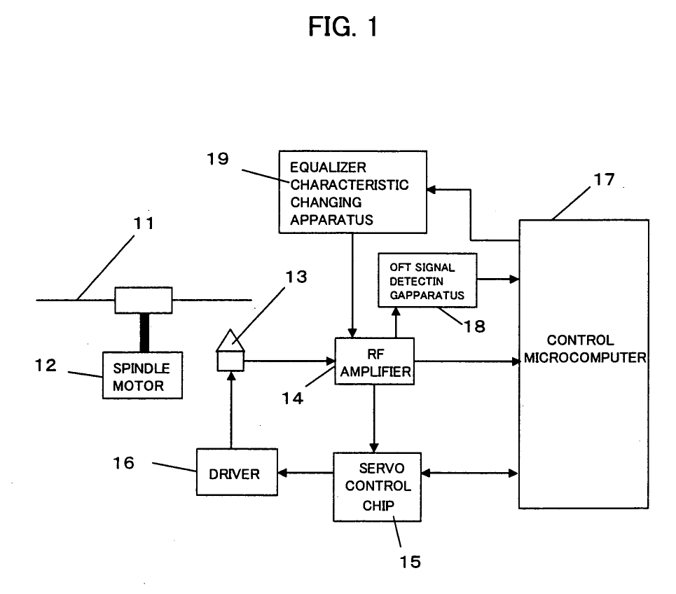

The signal processing apparatus for reproducing the optical disc according to the embodiments of the present invention is added to a conventional optical disc reproducing apparatus, and as shown in FIG. 1, comprises an OFT detecting apparatus 18 which is a signal detecting means and an equalizer characteristic changing apparatus 19 which is an equalizer gain changing means. The OFT detecting apparatus 18 detects an OFT signal having a higher frequency than a predetermined frequency, e.g., a frequency at 50 kHz or higher. Meanwhile, the equalizer characteristic changing apparatus 19 changes the equalizer gain for the RF signal read from an optical disc 11 in response to detection by the OFT detecting apparatus 18 of the OFT signal having a higher frequency than the predetermined frequency. These apparatuses may be incorporated inside other LSI.

The OFT signal mentioned above is a signal which stays at the L-level while a laser from a pick-up is tracing a track but becomes the H-level when the laser fails to trace.

The equalizer characteristic changing apparatus 19 usually increases the gain for high-frequency portions of in an effort to enhance the amplitude of the high-frequency portions of the RF signal. It may however reduce the gain depending upon a condition. More specifically, for example, if no signal is read properly owing to the large distortion of the RF signal, the gain is reduced. The condition is described below.
(1) In the case that no data is read and time-out occurs
(2) In the case that the number of errors is large

An optical disc reproducing apparatus according to the first embodiment of the present invention is what is obtained by adding this signal processing apparatus for reproducing the optical disc to a conventional optical disc reproducing apparatus.

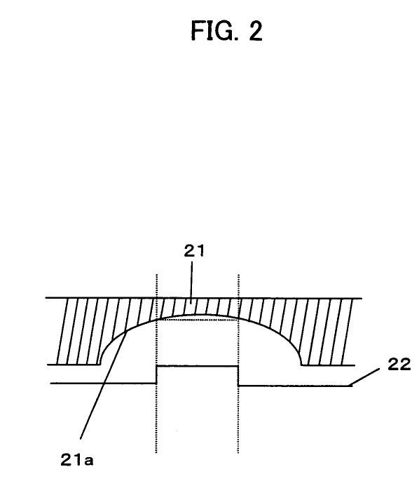

FIG. 2 is a waveform diagram which shows a method of generating the OFT signal. As shown in FIG. 2, a missing portion 21a of an RF signal 21 is detected through envelope detection, and an OFT signal 22 changes to the H-level when the level of the missing portion 21a of the RF signal 21 exceeds a certain threshold value. The OFT signal 22 is at the L-level when the threshold value is not surpassed. In an optical disc in which writing was done with optimal laser power, the OFT signal stays at the L-level unless off-the-track occurs.

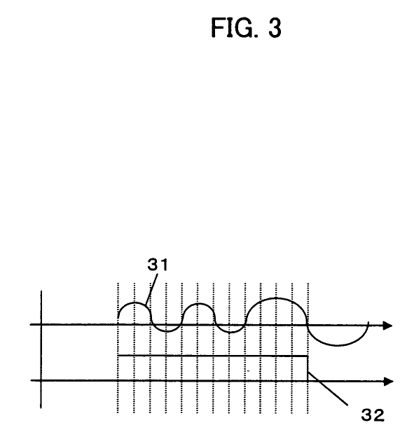

FIG. 3 is a drawing which shows a relationship between the RF signal and the OFT signal as it is when writing was not done with optimal laser power. An optical disc in which writing was not done with optimal laser power gives rise to an asymmetric RF signal 31. In this instance, despite no off-the-track, the RF signal 31 partially drops out under a similar circumstance to an off-the-track situation. This switches the OFT signal 32 to the H-level.

In addition, the higher the frequency of the RF signal 31 is, more significant the asymmetric profile is. Of the RF signal 31 written on the optical disc, it is the 3T component that has the highest frequency. The 3T component therefore is most asymmetric. The OFT signal often changes to the H-level in response to high frequency components such as the 3T component. The period of time that the OFT signal stays at the H-level is therefore very short.

The frequency of the OFT signal is usually about a few kHz through 30 kHz after the OFT signal has switched to the H-level upon occurrence of off-the-track. This is because the pick-up as it actually moves traverses a track on the disc. In the event described above however that the OFT signal changes to the H-level in response to data which contain the significantly asymmetric 3T signal, the frequency of the OFT signal is a few hundred kHz. This is because the frequency of the 3T signal is 700 kHz. The period of time that the OFT signal stays at the H-level is therefore very short.

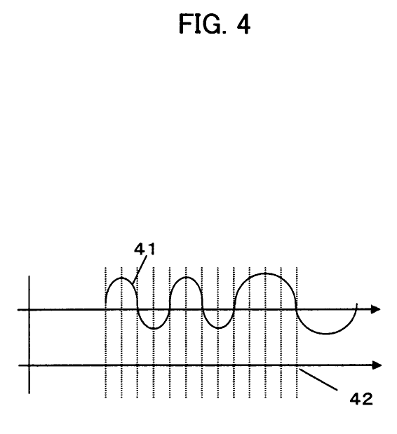

FIG. 4 is a waveform diagram representing a situation that the equalizer gain is increased. Denoted at 41 is the RF signal as it is with its amplitude intensified, while denoted at 42 is the OFT signal. When the amplitudes of high-frequency portions of the RF signal are increased, the OFT signal remains at the L-level.

The reason why the enhanced amplitudes of the high-frequency portions of the RF signal maintain the OFT signal at the L-level will now described. The OFT signal is obtained as a result of detection of a lower missing portion of the RF signal. Further, the amplitudes of the high-frequency portions including the 3T signal tend to be narrower than that of an ordinary signal. Hence, when the 3T signal having a narrower amplitude than usual continuously appears due to the asymmetric profile, a lower section of the RF signal looks partially missing. To prevent this, it is necessary that the amplitudes of the high-frequency portions including the 3T signal are enhanced, the missing portion in the lower section of the RF signal is consequently reduced, and the detection level for the OFT signal is not reached. As described above, the enhanced amplitudes of the high-frequency portions maintain the OFT signal at the L-level.

As a control microcomputer 17 or the like for instance detects the OFT signal while data are being read, it is possible to determine whether an optical disc currently played back is an optical disc in which writing was done with optimal laser power or an optical disc in which writing was not done with optimal laser power. This processing of ascertaining an optical disc is performed once at the start of reading of the optical disc for example. The ascertaining processing is thus carried out every time an optical disc is exchanged.

Since it is now possible to identify an optical disc, when the disc is an optical disc in which writing was done with optimal laser power, the equalizer gain is set small for jitter suppression, whereas to play back an optical disc in which writing was not done with optimal laser power, the equalizer gain is increased. This makes it possible to play back even an optical disc which has heretofore been impossible to play back.

A description will now be given on optical disc reproducing apparatus according to the first embodiment of the present invention which comprises this signal processing apparatus for reproducing the optical disc, while referring to the associated drawings.

FIG. 1 is a block diagram of the optical disc reproducing apparatus according to the first embodiment of the present invention.

The optical disc reproducing apparatus comprises a spindle motor 12 which rotates an optical disc 11, a pick-up 13 which reads a signal from the optical disc 11, an RF amplifier 14 which amplifies a signal from the pick-up 13, a servo control chip 15 which computes for servo control in accordance with a signal received from the RF amplifier 14, a driver 16 which amplifies a signal from the servo control chip 15 and drives the pick-up 13 up to a target point for the optical disc 11, a control microcomputer 17 which controls these, an OFT detecting apparatus 18 which generates the OFT signal from the RF signal, and an equalizer characteristic changing apparatus 19 which switches the equalizer gain in accordance with a signal from the control microcomputer 17.

The OFT detecting apparatus 18 described above is a circuit which determines whether the lower end level of the RF signal, namely, the level of the asymmetric portion of the RF signal is over the certain value, as described with reference to FIG. 2. Although not shown, a specific structure to this end is not unique to the present invention but has been used for an ordinary conventional disc reproducing apparatus.

The frequency of the OFT signal can be checked using an input capture function of the control microcomputer 17 for example. Describing in more specific details, with the OFT signal fed to the control microcomputer 17 via a predetermined terminal, the length of the H-level (or the L-level) is counted using an internal clock inside the microcomputer, thereby measuring the cycles of the H-level sections.

While the foregoing has described for the convenience of description that the OFT detecting apparatus 18 detects the OFT signal whose frequency exceeds the predetermined frequency, e.g., the OFT signal having a frequency which is equal to or higher than 50 kHz, in an actual circuit, the OFT detecting apparatus 18 detects the OFT signal regardless of the frequency in a similar manner to a conventional manner, and the control microcomputer 17 checks the frequency of the OFT signal as described above.

The structure of the equalizer characteristic changing apparatus 19 will now be described. It is possible, through direct control by the control microcomputer 17 of a terminal mounted to the RF amplifier for example, to adjust the equalizer gain. Alternatively, with the control microcomputer 17 providing a command to the servo control chip 15, the control microcomputer 17 may indirectly control via the servo control chip 15 for adjustment.

The block representing the equalizer characteristic changing apparatus 19, shown in FIG. 1, indicates a region in which the gain of the equalizer is adjusted using a switching command from the control microcomputer 17.

The functions of the control microcomputer 17 will now be described. As described above, the control microcomputer 17 is equipped with the function of measuring the OFT signal, the function of determining whether the frequency of thus measured OFT signal is higher than the predetermined frequency, and the function of controlling the settings for the terminal of the RF amplifier for gain adjustment.

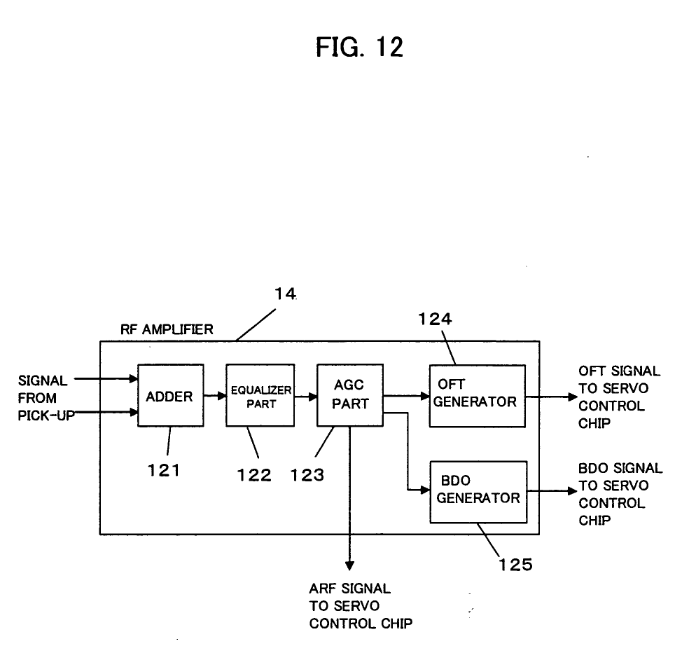

A specific structure of the RF amplifier 14 will now be described with reference to FIG. 12. The RF amplifier 14 comprises the following blocks for instance:

a) an adder 121;

The adder 121 sums up multiple signals fed from the pick-up. The signal resulting from the addition is called the RF signal.

b) an equalizer part 122;

The equalizer part 122 increases the amplitudes of high-frequency portions of the RF signal which has passed through the adder 121.

c) an AGC part 123;

The AGC part 123 executes automatic gain control upon the RF signal which has passed through the equalizer part 122, controlling the amplitude of a low-frequency portion (lT) of the RF signal always to a constant amplitude. An audio RF signal, i.e., an ARF signal from the AGC part 123 is fed to the servo control chip 15. This signal is used for identification of audio data within the servo control chip 15.

d) an OFT generator 124;

The OFT generator 124 detects, through envelope detection, a lower missing portion in the RF signal which has passed through the AGC part 123, and compares the level of the lower missing portion of the RF signal with a constant value. If the lower missing portion of the RF signal is beyond the constant value, the OFT generator 124 generates an output signal which will change the OFT signal to the H-level. The servo control chip 15 and the control microcomputer 17 use this OFT signal; and

e) a BDO generator 125

The BDO generator 125 detects, through envelope detection, an upper missing portion in the RF signal which has passed through the AGC part 123. This is because when the RF signal partially drops out due to a scratch or the like, it is the upper part of the RF signal that goes missing. An upper part of the RF signal becomes missing when reflected light is insufficient. If the upper missing portion of the RF signal is beyond a constant value, the BDO generator 125 generates an output signal which will change the BDO signal to the H-level. The servo control chip 15 uses this BDO signal.

This optical disc reproducing apparatus detects the OFT signal while data on an optical disc are being read, and upon detection of the OFT signal exceeding a certain constant frequency, determines that this is an optical disc in which writing was done with non-optimal laser power and changes the gain of the equalizer, e.g., increases the equalizer gain.

Describing this in more specific details, the control microcomputer 17 receives the OFT signal generated by the OFT detecting apparatus 18, and measures the frequency. When judging that the measured frequency is higher than the certain constant frequency, the control microcomputer 17 sets up the gain in the equalizer characteristic changing apparatus 19 through control of a terminal, and changes the gain of the equalizer, e.g., increases the equalizer gain.

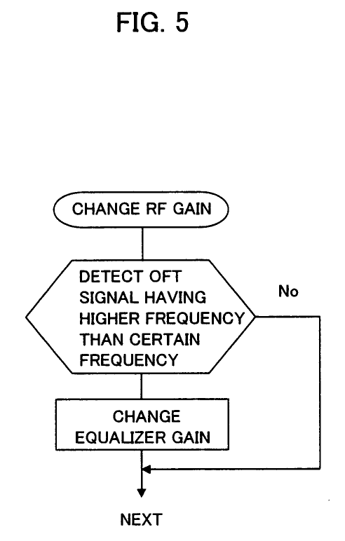

The procedure for changing the gain of the equalizer according to the first embodiment will now be described. FIG. 5 is a flow chart of a method of switching the RF signal equalizer gain in the first embodiment of the present invention. The frequency of the OFT signal is detected while data are being read, during automatic adjustment or on other occasion, and when the frequency is found exceeding the certain constant frequency, it is determined that an optical disc is one in which writing was done with non-optimal laser power, and the gain of the equalizer is changed, e.g., increased. This makes it possible to play back even this optical disc which has heretofore been impossible to play back.

While the foregoing has described that the gain of the equalizer is increased upon detection of the OFT signal whose frequency is equal to or exceeds 50 kHz for instance in the embodiment described above, the gain of the equalizer may be increased for every detection of the OFT signal regardless of the frequency, in which case as well a similar effect to the effect above is obtained.

(Second Embodiment)

The second embodiment of the present invention will now be described.

In general, the RF amplifier 14 is capable of outputting the BDO signal whose function is to detect a scratch on an optical disc. The BDO signal is a signal which changes to the H-level when an upper missing portion of a signal from an optical disc exceeds a constant value but stays at the L-level in a normal situation, and as such, can be used for detection of a scratch on an optical disc. The reason why an upper portion of the RF signal becomes missing is because a scratch or the like creates a dark portion. In this regard, the BDO signal has a function of detecting a scratch.

When moving over a scratch, the pick-up often fails to follow a track in a normal manner. Due to this, during the H-level period of the BDO signal or for a while (1 ms through 2 ms) after the BDO signal has changed to the L-level from the H-level, the OFT signal tends to be at the H-level. When detection of the OFT signal is performed outside the H-level period of the BDO signal or the temporary period after the BDO signal has changed to the L-level from the H-level, it is possible to more securely identify an optical disc in which writing was done with non-optimal laser power.

The reason of detecting the OFT signal outside the H-level period of the BDO signal or the temporary period after the BDO signal has changed to the L-level from the H-level will now be described. While used for identification of an optical disc on which the RF signal is asymmetric, the OFT signal originally aims at determining whether a laser is tracing a track. After the pick-up move passed a scratch, the pick-up often fails to trace a track normally. During the period that BDO=H-level or immediately after the BDO signal has changed to the L-level from the H-level therefore, the OFT signal may change to the H-level not because of the asymmetric RF signal but due to the originally intended purpose of the OFT signal. It is hence necessary to measure the cycles of the OFT signal, avoiding these periods of time.

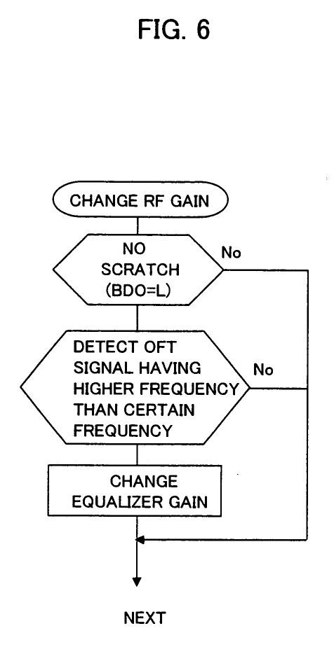

The procedure for changing the gain of the equalizer according to the second embodiment will now be described. FIG. 6 is a flow chart of a method of switching the RF signal equalizer gain in the second embodiment of the present invention. First, the state that BDO signal is at the L-level is confirmed while data are being read, during automatic adjustment or on other occasion. The frequency of the OFT signal is then detected, and if the frequency exceeds a certain constant frequency, it is determined that an optical disc is one in which writing was done with non-optimal laser power, and the gain of the equalizer is changed, e.g., increased. This makes it possible to play back even this optical disc which has heretofore been impossible to play back. This also makes it possible to more securely identify an optical disc in which writing was done with non-optimal laser power.

(Third Embodiment)

The third embodiment of the present invention will now be described.

In general, the RF amplifier 14 or the servo control chip 15 is capable of outputting the tracking lock signal with which off-the-track on an optical disc is detected. When proper tracking is not maintained, the OFT signal naturally tends to be at the H-level. When detection of the OFT signal is performed outside the OFF-period of the tracking lock signal, it is possible to more securely identify an optical disc in which writing was done with non-optimal laser power.

The tracking lock signal is generated inside the servo control chip 15. Further, the tracking lock signal is used to determine whether tracking is locked or not in a conventional system as well. The present invention is characterized in detecting whether there is any period that the OFT signal is at the H-level while tracking is locked (though the OFT signal is supposed to stay at the L-level) and accordingly determining whether an asymmetric RF signal is contained. When tracking is locked, the OFT signal is supposed to stay at the L-level.

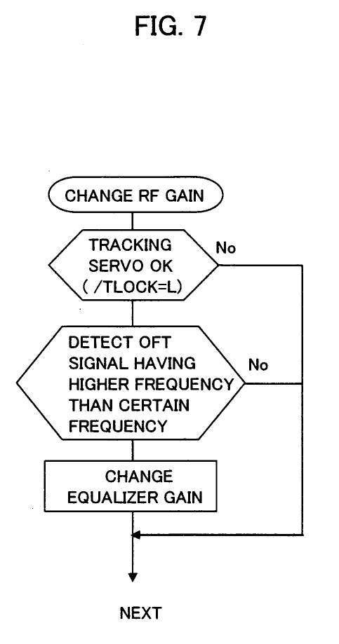

The procedure for changing the gain of the equalizer according to the third embodiment will now be described. FIG. 7 is a flow chart of a method of switching the RF signal equalizer gain in the third embodiment of the present invention. For instance, first, locking of tracking is confirmed in accordance with the tracking lock signal/TLOCK while data are being read, during automatic adjustment or on other occasion. The frequency of the OFT signal is then detected, and if the frequency exceeds a certain constant frequency, it is determined that an optical disc is one in which writing was done with non-optimal laser power, and the gain of the equalizer is changed, e.g., increased. This makes it possible to play back even this optical disc which has heretofore been impossible to play back. This also makes it possible to more securely identify an optical disc in which writing was not done with optimal laser power.

(Fourth Embodiment)

The fourth embodiment of the present invention will now be described.

In general, the RF amplifier 14 or the servo control chip 15 is equipped with a function of detecting locking of the number of revolutions of or PLL ON for an optical disc, and having this function, outputs a signal called a “number-of-revolutions lock signal” (hereinafter abbreviated as a “CLV signal”) or a “PLLON signal”. When the number of revolutions of an optical disc can not be maintained or PLL can not be ON, the OFT signal naturally tends to be at the H-level. When detection of the OFT signal is performed outside the OFF-period of the CLV signal or the PLL ON signal mentioned above, it is possible to more securely identify an optical disc in which writing was done with non-optimal laser power.

The CLV signal mentioned above is a signal which is generated inside the servo control chip 15 according even to the conventional techniques. The control microcomputer 17 can read in the CLV signal when demanded so by a command. The PLL ON signal similarly is a signal which is generated inside the servo control chip 15, not inside the RF amplifier 14, according even to the conventional techniques. The control microcomputer 17 can read in the PLL ON signal as well when demanded so by a command.

The CLV signal and the PLL ON signal will now be described in detail. The CLV signal is a signal which expresses whether the number of revolutions of a disc has reached the number of revolutions which has been set. For rotations at a proper number of revolutions, an indispensable condition is that tracking described above is locked. In short, whether locking is locked may be determined with reference to the number-of-revolutions lock signal instead of referring to the tracking lock signal described earlier. An advantage of using the number-of-revolutions lock signal lies in more reliable detection that tracking is ON as compared with where the tracking lock signal is used. A disadvantage is a slight time loss before locking of the number of revolutions even tracking is already is ON.

The PLL ON signal is a signal based on which whether data are read normally is determined. While the number of revolutions must be maintained constant in the case of a CD-DA music CD, with respect to data on a CD-ROM, there will be no problem even if data are read before the number of revolutions of a disc reaches the set number of revolutions.

The situation that data are being read means that tracking is locked, and therefore, the present invention may be implemented using the PLL ON signal instead of using the tracking lock signal.

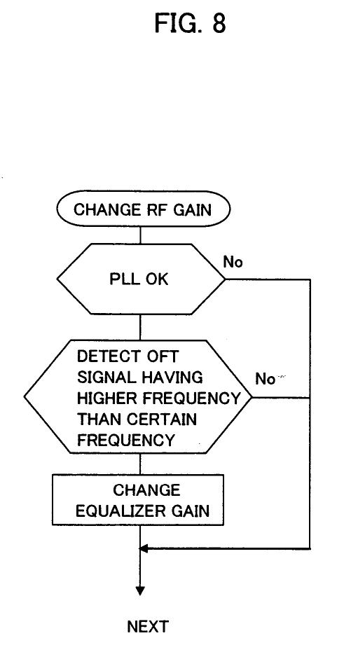

The procedure for changing the gain of the equalizer according to the fourth embodiment will now be described. FIG. 8 is a flow chart of a method of switching the RF signal equalizer gain in the fourth embodiment of the present invention. For example, first, locking of PLL is confirmed in accordance with PLL lock signal (=PLL ON signal) while data are being read, during automatic adjustment or on other occasion. The frequency of the OFT signal is then detected, and if the frequency exceeds a certain constant frequency, it is determined that an optical disc is one in which writing was done with non-optimal laser power, and the gain of the equalizer is changed, e.g., increased. This makes it possible to play back even this optical disc which has heretofore been impossible to play back. This also makes it possible to more securely identify an optical disc in which writing was done with non-optimal laser power.

INDUSTRIAL APPLICABILITY

The RF equalizer gain adjustment according to the present invention is useful to make it possible to play back even such an optical disc which has heretofore been impossible to play back.

1. A signal processing apparatus for reproducing an optical disc, comprising:
a signal detecting means which detects whether the level of the asymmetric portion of an RF signal is higher than a predetermined level upon occurrence of the asymmetric portion in the high-frequency range of said RF signal read from an optical disc; and
an equalizer gain changing means which changes the equalizer gain for said RF signal upon detection by said signal detecting means that the level of the asymmetric portion of said RF signal is higher than said predetermined level.

2. The signal processing apparatus for reproducing the optical disc of claim 1, wherein said signal detecting means detects a black drop out signal, and
only when it is determined from said black drop out signal that said optical disc has no scratch, said equalizer gain changing means changes the equalizer gain for said RF signal upon detection by said signal detecting means that the level of the asymmetric portion of said RF signal is higher than said predetermined level.

3. The signal processing apparatus for reproducing the optical disc of claim 1, wherein said signal detecting means detects a tracking lock signal, and
only when it is determined from said tracking lock signal that tracking of said optical disc is locked, said equalizer gain changing means changes the equalizer gain for said RF signal upon detection by said signal detecting means that the level of the asymmetric portion of said RF signal is higher than said predetermined level.

4. The signal processing apparatus for reproducing the optical disc of claim 1, wherein said signal detecting means detects a PLL lock signal, and
only when it is determined from said PLL lock signal that PLL for said optical disc is locked, said equalizer gain changing means changes the equalizer gain for said RF signal upon detection by said signal detecting means that the level of the asymmetric portion of said RF signal is higher than said predetermined level.

5. An optical disc reproducing apparatus which comprises the signal processing apparatus for reproducing the optical disc of claim 1.

6. A signal processing apparatus for reproducing an optical disc, comprising:
an off-track-signal detecting means which detects whether the level of the asymmetric portion of an RF signal is higher than a predetermined level upon occurrence of the asymmetric portion in the high-frequency range of said RF signal read from an optical disc, thereby detecting an off-track signal whose frequency is higher than said predetermined frequency; and
an equalizer gain changing means which changes the equalizer gain for said RF signal read from said optical disc in response to detection by said off-track-signal detecting means of said off-track signal whose frequency is higher than said predetermined frequency.

7. An RF signal equalizer gain adjustment method, comprising:
a signal detecting step of detecting whether the level of the asymmetric portion of an RF signal is higher than a predetermined level upon occurrence of the asymmetric portion in the high-frequency range of said RF signal read from an optical disc; and
an equalizer gain changing step of changing the equalizer gain for said RF signal upon detection at said signal detecting step that the level of the asymmetric portion of said RF signal is higher than said predetermined level.

8. The RF signal equalizer gain adjustment method of claim 7, wherein a black drop out signal is detected at said signal detecting step, and
at said equalizer gain changing step, only when it is determined from said black drop out signal that said optical disc has no scratch, the equalizer gain for said RF signal is changed upon detection at said signal detecting step that the level of the asymmetric portion of said RF signal is higher than said predetermined level.

9. The RF signal equalizer gain adjustment method of claim 7, wherein a tracking lock signal is detected at said signal detecting step, and
at said equalizer gain changing step, only when it is determined from said tracking lock signal that tracking of said optical disc is locked, the equalizer gain for said RF signal is changed upon detection at said signal detecting step that the level of the asymmetric portion of said RF signal is higher than said predetermined level.

10. The RF signal equalizer gain adjustment method of claim 7, wherein a PLL lock signal is detected at said signal detecting step, and
at said equalizer gain changing step, only when it is determined from said PLL lock signal that PLL for said optical disc is locked, the equalizer gain for said RF signal is changed upon detection at said signal detecting step that the level of the asymmetric portion of said RF signal is higher than said predetermined level.
